(19) United States
(12) Patent Application Publication
(10) Pub. No.: US 2009/0307680 A1
(43) Pub. Date: Dec. 10, 2009

(54) SIDE-BY-SIDE DRIVER INSTALLATION

(75) Inventors: Adina M. Trufinescu, Redmond, WA (US); Oliver H. Foehr, Mercer Island, WA (US); Ramesha Chandrashekhar, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/135,135

(22) Filed: Jun. 6, 2008

(51) Int. Cl. G06F 9/44

(52) U.S. Cl. 717/170

(57) ABSTRACT

In one or more embodiments, driver files are assigned strongly-named locations in a system directory. Different versions of driver files are assigned their own different, strongly-named locations. By assigning different versions of driver files to different strongly-named locations, different versions of the same driver file can be installed, managed, and upgraded without loss of functionality associated with other installed driver file versions. In at least some embodiments, a text file includes named sections that direct installation of a particular driver package. The text file can include a list of file dependencies that enable files to be associated with individual strongly-named locations.

### BACKGROUND

Driver files, such as printer driver files, are typically installed into a single folder on a particular computing device. When new versions of driver files are received, the new versions are often times installed into the same single folder. When new file versions share the same name as old file versions, as is often the case, the old file versions are typically overwritten in favor of the new file versions. Doing so, however, can change or lose functionality associated with the old file versions. This can cause undesirable system operation such as crashes and the like.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one or more embodiments, driver files are assigned strongly-named locations in a system directory. Different versions of driver files are assigned their own different, strongly-named locations. By assigning different versions of driver files to different strongly-named locations, different versions of the same driver file can be installed, managed, and upgraded without loss of functionality associated with other installed driver file versions.

In at least some embodiments, a text file includes named sections that direct installation of a particular driver package. The text file can include a list of file dependencies that enable files to be associated with individual strongly-named locations.

### BRIEF DESCRIPTION OF THE DRAWINGS

The same numbers are used throughout the drawings to reference like features.

FIG. 1 illustrates an example operating environment in which various inventive principles can be employed in accordance with one or more embodiments.

FIG. 2 illustrates an example system in accordance with one embodiment.

FIG. 3 illustrates an example driver package in accordance with one or more embodiments.

FIG. 4 is a flow diagram that illustrates steps in a method in accordance with one or more embodiments.

FIG. 5 illustrates an example computing device that can implement various embodiments.

### DETAILED DESCRIPTION

Overview

In one or more embodiments, driver files are assigned strongly-named locations in a system directory. Different versions of driver files are assigned their own different, strongly-named locations. By assigning different versions of driver files to different strongly-named locations, different versions of the same driver file can be installed, managed, and upgraded without loss of functionality associated with other installed driver file versions.

In at least some embodiments, a text file includes named sections that direct installation of a particular driver package. The text file can include a list of file dependencies that enable files to be associated with individual strongly-named locations.

The techniques described herein can be used in connection with any suitable driver files including, by way of example and not limitation, printer driver files. The discussion in this document uses printer driver files for examples. It is to be appreciated and understood that other driver files can be used without departing from the spirit and scope of the claimed subject matter.

In the discussion that follows, a section entitled “Operating Environment” describes but one operating environment that can be utilized to practice the inventive principles described herein in accordance with one or more embodiments. Following this, a section entitled “Example Embodiment” describes an example embodiment that utilizes the principles described herein. Following this, a section entitled “Implementation Example” describes an example implementation in accordance with one or more embodiments. Next, a section entitled “Example Method” describes an example method in accordance with one or more embodiments. Last, a section entitled “Example System” describes a system that can be utilized to implement one or more embodiments.

Having discussed an overview of the inventive embodiments, consider now a discussion of an example operating environment.

Operating Environment

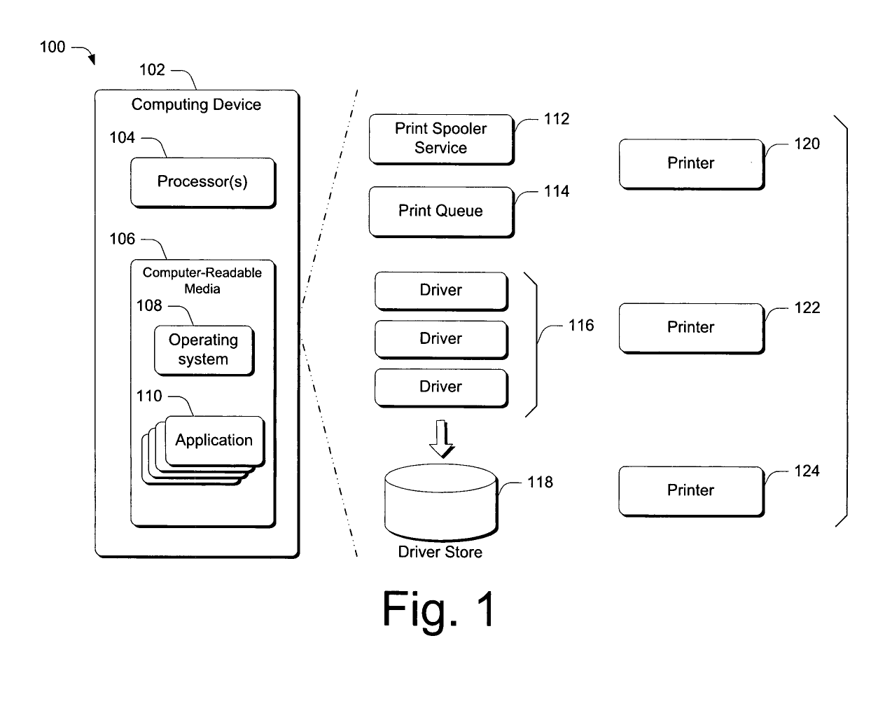

FIG. 1 illustrates an example operating environment, generally at 100, in which various inventive principles can be employed in accordance with one or more embodiments.

Environment 100 includes a computing device 102 that can be used to implement various embodiments described herein. The computing device can comprise any suitably-configured computing device including, by way of example and not limitation, a print server. Print servers can be used to share printers on a network. Client computers typically connect to the print server to print to its shared printers, such as printers 120, 122, and 124.

Computing device 102 can typically include one or more processors 104, one or more computer-readable media 106, an operating system 108 and one or more applications 110 that reside on the computer-readable media and which are executable by the processor(s).

The computing device can include a print spooler service 112, a print queue 114, various drivers 116 and a driver store 118. The print spooler service 112 manages print jobs and print queues on computing device 102. Print queue 114 is a representation of a print device, for example a physical printer. Opening a print queue displays active print jobs and their statuses. Drivers 116 are used by print queues to print to a physical print device such as a printer. Drivers 116 are stored in driver store 118 in accordance with techniques described herein using strongly-named locations.

The computer-readable media 106 can include, by way of example and not limitation, all forms of volatile and non-volatile memory and/or storage media that are typically associated with a computing device. Such media can include ROM, RAM, flash memory, hard disk, removable media and the like.

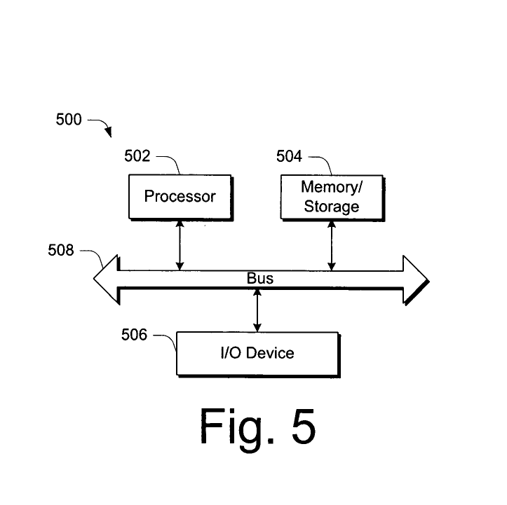

The computing device can be embodied as any suitable computing device such as, by way of example and not limitation, a desktop computer, a portable computer, a handheld computer such as a personal digital assistant, and the like. One example of a computing device is shown and described below in relation to FIG. 5.

Having discussed a general operating environment, consider now an example embodiment.

### Example Embodiment

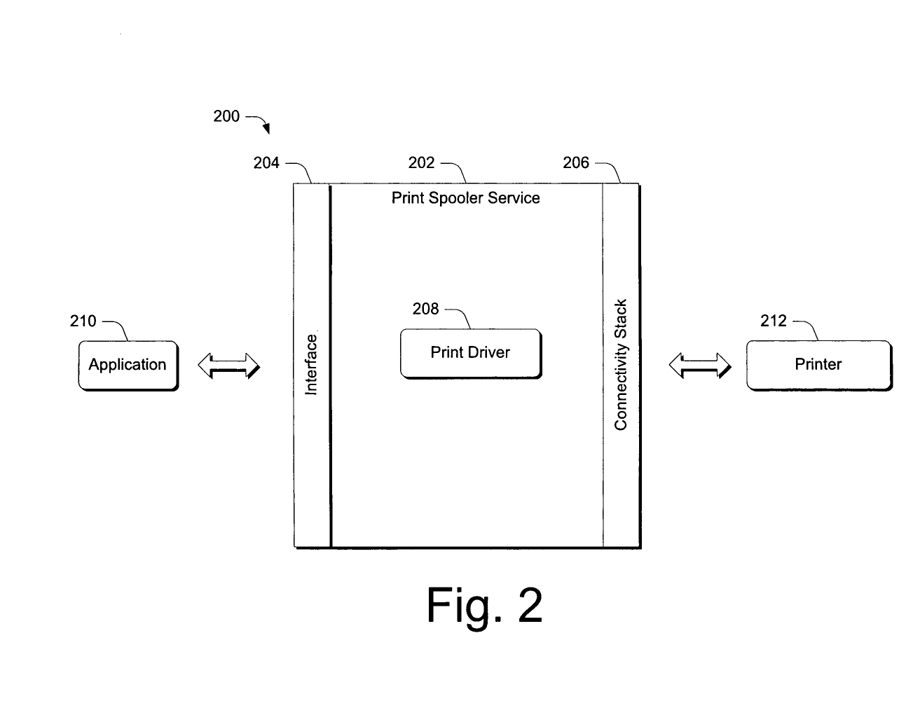

FIG. 2 illustrates an example system in accordance with one embodiment generally at 200. In this example, system 200 includes a print spooler service 202 having an interface 204 and a connectivity stack 206. The print spooler service includes or otherwise makes use of one or more print drivers 208. Any suitable print spooler service can be utilized an example of which is Microsoft's Windows® Print Spooler Service. The print spooler service utilizes interface 204 to allow clients, such as application 210, to call into the service and request printing services, such as those that can be utilized to print a document. The print spooler service routes the document to a physical device, such as printer 212, for printing.

In operation, there are different layers of hardware and software between interface 204 and printer 212. For example, connectivity stack 206 can be utilized to enable connectivity using any suitable type of connectivity scheme such as line print terminal (LPT), a serial port, TCP/IP, USB, and the like. For each printing device that is available on the market, a printer driver such as printer driver 208 is utilized. When a document is printed, the document is typically sent in a format that is specific to the client or application sending the document, such as application 210. Printer 212 typically recognizes a format that is different from the application format. The application format is typically converted to a device-recognized format by the printer driver. The printer driver, which is typically a DLL, is loaded into the print spooler service process and then through various spooler methods, the driver is invoked with data received from application 210.

The printer driver then knows how to call into the print spooler service to send a representation of the document, such as a PDL representation, to the printer 212.

When a new or different printing device is connected to a client computing device, a print queue associated with the new or different printing device can be installed. When the print queue is installed, the print spooler service makes sure, through the connectivity layers, that the client computing device is connected to the printing device and that the printer driver knows how to render data for this particular printing device.

Oftentimes, operating systems provide sets of so-called core printer drivers. Core printer drivers provide standard driver functionality for different devices and operating systems. In addition, individual printing device manufacturers often look to extend or differentiate the core printer drivers through an extension model that employs so-called “dependent files” or DLLs. So, for example, a class of Hewlett-Packard printers may use a certain set of dependent files, whereas a class of Canon printers may use a different set of dependent files, both of which extend the functionality provided by the core printer drivers. In this case, one set of dependent files may be developed to work with a first operating system, and another set of dependent files may be developed to work with a second operating system.

In one or more embodiments, multiple different versions of dependent files and core files can be provided or otherwise installed in a side-by-side fashion. To accomplish this, in at least some embodiments, driver files are assigned strongly-named locations in a system directory. Different versions of driver files are assigned their own different, strongly-named locations. By assigning different versions of driver files to different strongly-named locations, different versions of the same driver file can be installed, managed, and upgraded without loss of functionality associated with other installed driver file versions. In at least some embodiments, a text file includes named sections that direct installation of a particular driver package. The text file can include a list of file dependencies that enable files to be associated with individual strongly-named locations.

In the discussion that follows, the following terminology is used. A “driver package” refers to a package that can contain driver DLLs and data files, .cat files (i.e. catalog files), an .inf file (i.e. a text file described just below), and a component.man file (i.e. a component manifest file). An “.inf file” is a text file containing named sections that direct installation of a given component or driver package. A “package published name” is the name of the .inf file that identifies the content of a package and is used as a unique identifier to search for the existence of a driver package in the driver store. A “package identifier” is a unique identifier that represents a directory created for a given version.

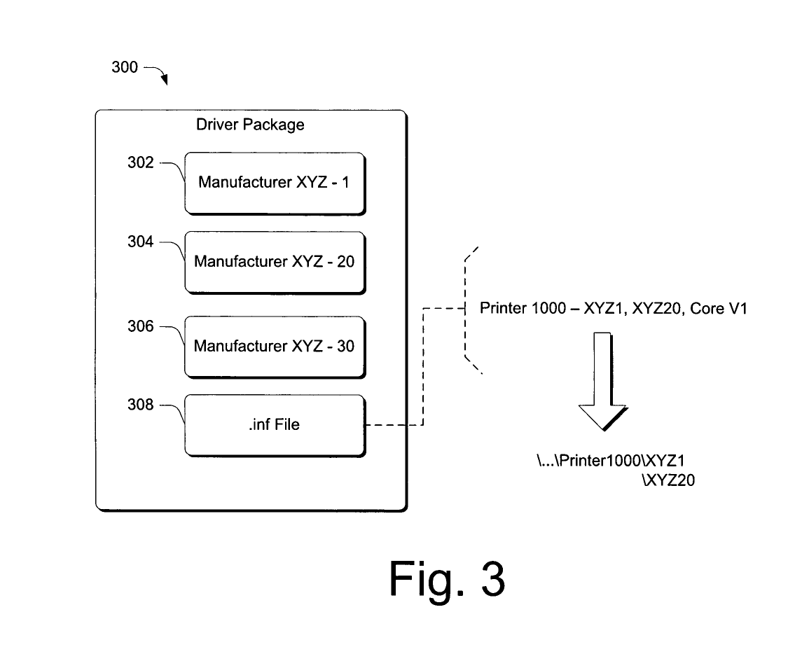

FIG. 3 illustrates an example driver package in accordance with one or more embodiments generally at 300. Assume in this example that driver package 300 includes all of the drivers for a particular set of printing devices. So, for example, the driver package might include drivers 302, 304, and 306. In addition, the driver package includes an .inf file 308. In this particular example, the .inf file specifies the core driver package and dependent files that are utilized by particular printer models. So, for example, Printer 1000 utilizes core driver package “Core V1”, as well as dependent files “XYZ1” and “XYZ20”. Other printer models can be described in the .inf file as well.

When a driver is to be installed, software code, such as a loader module, accesses the .inf file 308, parses the file, and ascertains which files are to be installed in which location. In the FIG. 3 example, the .inf file indicates the dependent files for Printer 1000. The software code identifies, from the .inf file, a particular sub-directory in which the dependent files are to be placed. In the illustrated and described embodiment, the sub-directory can be identified by a package identifier. The software code then creates the particular sub-directory which, in this example, constitutes a strongly-named location associated with the dependent files, and saves the dependent files into the created sub-directory. In this particular example, the sub-directory is indicated at “\ . . . \Printer1000\” and the files “XYZ1” and “XYZ20” have been saved into the sub-directory. Internally, in the print spooler service, there are references to the files that are located in the various sub-directories. Different versions of the same dependent driver files can be saved in a different strongly-named location thus allowing different versions of the same driver files to be installed in a side-by-side fashion.

Implementation Example

As an example of a specific implementation, consider the following. The implementation example is described in the context of a Windows® Print Spooler Service. In this particular example, print driver DLLs are installed under:
% windir %\system32\spool\drivers\<arch>\3 directory.

If a driver model is installed from a vendor driver package, located in the driver store at “% windir %\system32\DriverStore\FileRepository\prnlx001.inf_fl3f0471”, a sub-directory “3\pmlx001.inf_fl3f0471” is created where the driver's files are installed. In one or more embodiments, the files are created as File System hard links pointing to the actual file in the driver store to avoid the duplication of the files on the system's disk.

Likewise, the files in a core driver package, located in the driver store at “% windir %\system32\DriverStore\FileRepository\ntprint.inf_{—}99bf01c4”, are installed under a “3\ntprint.inf_{—}99bf01c4” sub-directory, in the same manner as the model files.

Having considered an example embodiment and an implementation example, consider now an example method in accordance with one or more embodiments.

Example Method

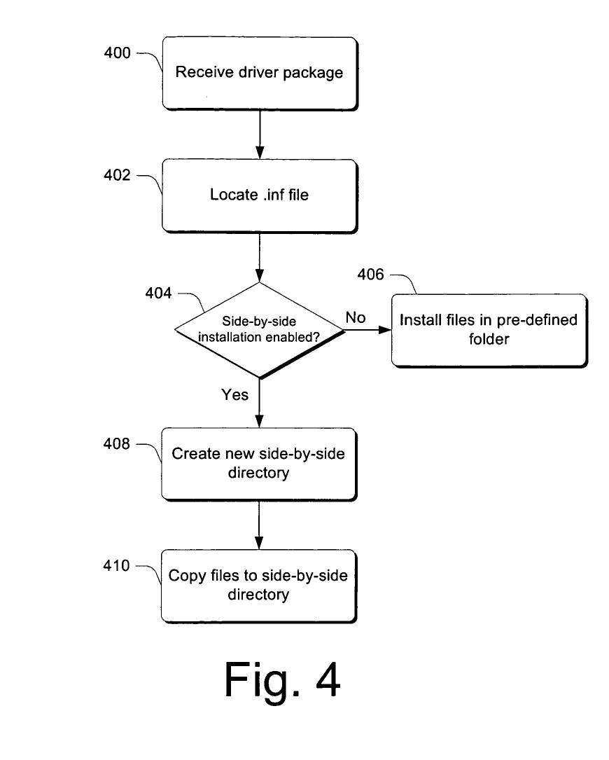

FIG. 4 is a flow diagram that illustrates steps in a method in accordance with one or more embodiments. The method can be implemented in connection with any suitable hardware, software, firmware, or combination thereof. In at least some embodiments, the method can be implemented in software which may or may not comprise part of a print spooler service.

Step 400 receives a driver package. Any suitable driver package can be received. For example, the received driver package can comprise a driver package associated with core driver files. Alternately or additionally, the received driver package can comprise a driver package associated with dependent driver files. Step 402 locates an .inf file included in the driver package.

Step 404 processes the .inf file and ascertains whether side-by-side installation is enabled. This step can be performed in any suitable way. For example, side-by-side installation can be indicated by having a particular flag or key word in the .inf file set. If side-by-side installation is not enabled, then step 406 installs files in the driver package in a pre-defined folder. If, on the other hand, side-by-side installation is enabled, step 408 creates a new side-by-side directory and step 410 copies files in the driver package to the side-by-side directory.

Having considered an example method, consider now an example system in accordance with one or more embodiments.

Example System

FIG. 5 illustrates an example computing device 500 that can implement the various embodiments described above. Computing device 500 can be, for example, various computing devices, such as that illustrated in FIG. 1 or any other suitable computing device such as a print server and the like.

Computing device 500 includes one or more processors or processing units 502, one or more memory and/or storage components 504, one or more input/output (I/O) devices 506, and a bus 508 that allows the various components and devices to communicate with one another. Bus 508 represents one or more of any of several types of bus structures, including a memory bus or memory controller, a peripheral bus, an accelerated graphics port, and a processor or local bus using any of a variety of bus architectures. Bus 508 can include wired and/or wireless buses.

Memory/storage component 504 represents one or more computer storage media. Component 504 can include volatile media (such as random access memory (RAM)) and/or nonvolatile media (such as read only memory (ROM), Flash memory, optical disks, magnetic disks, and so forth). Component 504 can include fixed media (e.g., RAM, ROM, a fixed hard drive, etc.) as well as removable media (e.g., a Flash memory drive, a removable hard drive, an optical disk, and so forth).

One or more input/output devices 506 allow a user to enter commands and information to computing device 500, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media”.

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Conclusion

In one or more embodiments, driver files are assigned strongly-named locations in a system directory. Different versions of driver files are assigned their own different, strongly-named locations. By assigning different versions of driver files to different strongly-named locations, different versions of the same driver file can be installed, managed, and upgraded without loss of functionality associated with other installed driver file versions. In at least some embodiments, a text file includes named sections that direct installation of a particular driver package. The text file can include a list of file dependencies that enable files to be associated with individual strongly-named locations.

The techniques described herein can be used in connection with any suitable driver files including, by way of example and not limitation, printer driver files.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method comprising:
receiving a driver package;
processing the driver package effective to create one or more new sub-directories associated with files in the driver package; and
copying files in the driver package to the one or more sub-directories, wherein different versions of same driver files are copied to different sub-directories.

2. The method of claim 1, wherein the driver package comprises a printer driver package.

3. The method of claim 1, wherein the driver package comprises a core driver package.

4. The method of claim 1, wherein the driver package comprises a driver package associated with dependent files configured for use with core driver files.

5. The method of claim 1, wherein said processing comprises locating a text file in the driver package and creating said one or more new sub-directories responsive to information contained in the text file or version-specific name of the text file.

6. The method of claim 1, wherein said processing comprises ascertaining, from a text file in the driver package, whether side-by-side installation is enabled and, if so, performing said copying of files.

7. A computer-implemented method comprising:
receiving a printer driver package;
locating, within the printer driver package, a text file that directs installation of the printer driver package;
placing files in the printer driver package in a driver store;
creating a strongly-named sub-directory associated with the printer driver package; and
creating file system hard links in the strongly-named sub-directory that point to associated files in the driver store.

8. The method of claim 7, wherein the printer driver package comprises a core printer driver package.

9. The method of claim 7, wherein the printer driver package comprises a printer driver package associated with dependent files configured for use with printer core driver files.

10. The method of claim 7 further comprising ascertaining, from the text file, whether side-by-side installation is enabled and, if so, performing said creating a strongly-named sub-directory and said creating file system hard links.

11. The method of claim 7, wherein said text file is configured to enable different versions of same printer driver files to be copied to different sub-directories.

12. One or more computer-readable storage media embodying computer-readable instructions which, when executed, implement a method comprising:
receiving a printer driver package;
processing the printer driver package effective to create one or more strongly-named sub-directories associated with files in the driver package; and
using the strongly-named sub-directories to enable different versions of same printer driver files to be installed in a side-by-side fashion.

13. The one or more computer-readable storage media of claim 12, wherein the printer driver package comprises a core printer driver package.

14. The one or more computer-readable storage media of claim 12, wherein the printer driver package comprises a printer driver package associated with dependent files configured for use with core printer driver files.

15. The one or more computer-readable storage media of claim 12, wherein said processing comprises locating a text file in the printer driver package and creating said one or more strongly-named sub-directories responsive to information contained in the text file or version-specific name of the text file.

16. The one or more computer-readable storage media of claim 12, wherein said processing comprises ascertaining, from a text file in the printer driver package, whether side-by-side installation is enabled and, if so, creating said one or more strongly-named sub-directories.

17. The one or more computer-readable storage media of claim 12, wherein said using comprises creating file system hard links in the strongly-named sub-directories that point to associated printer driver files in a driver store.

18. The one or more computer-readable storage media of claim 12, wherein said one or more strongly-named sub-directories are utilized to allow installation of both core printer driver files and dependent files configured for use with core printer driver files.

19. The one or more computer-readable storage media of claim 12, wherein said one or more computer-readable storage media are embodied on a print server.

20. The one or more computer-readable storage media of claim 12, wherein said one or more computer-readable storage media are embodied on a computing device.
